(19) United States
(12) Patent Application Publication
(10) Pub. No.: US 2013/0262623 A1
(43) Pub. Date: Oct. 3, 2013

(54) Method and apparatus for providing services to clients of static or dynamic hardware.

(71) Applicant: David Hardy Nall, Texarkana, TX (US)

(72) Inventor: David Hardy Nall, Texarkana, TX (US)

(21) Appl. No.: 13/436,876

(22) Filed: Mar. 31, 2012

(51) Int. Cl. G06F 15/16

(52) U.S. Cl. 709/217

(57) ABSTRACT

According to one embodiment, a method and apparatus for providing services to clients of static or dynamic hardware. The apparatus comprising a network interface directly coupled with the apparatus's system memory and processors through an internal interconnect in order to provide direct communication to devices connected to the apparatus without the use of the network layer of the Open Systems Interconnection model. The network interface of the said apparatus is also configured to act as the network's DHCP host and residential gateway. The method includes when receiving a hardware change request from a client using the specified device in the request for the specified function requested without interrupting the services.

### BACKGROUND

Electronic devices are becoming increasingly mobile and advanced. Many cell phones today have their own operating systems, file systems, and run applications on an event driven basis through a graphical user interface (GUI). Tablets provide these functionalities as well and are easier to carry around than a personal computer (PC) but do not have as high of a capacity for memory storage and computing speed due to physical limitations. At the present time these devices all work independent of each other. For example, a tablet operates as a standalone device and the user session of the operator of said tablet cannot be seamlessly transferred to the operator's Smartphone, television, or PC. The present invention is designed to overcome the limitations of these devices by providing services to the client's and adapting to requested changes of hardware without interrupting the client's user session.

### SUMMARY OF THE INVENTION

Preferred embodiments of the invention include the electronics one skilled in the art would find in a traditional server but also includes a network interface comprising a plurality of PHYceivers interfaced to the apparatus' system memory and processor through a switched fabric. However, it is to be understood by those skilled in the art that the claims of the present invention may be achieved with hardware or software or a combination thereof. The preferred embodiment will be assigned three data link layer addresses: one from the perspective of a wide area network (WAN), two from the perspective of a local area network (LAN)/wireless local area network (WLAN)—one for the server portion of the embodiment and one for the router portion of the embodiment. When a data frame is received from the LAN/WLAN the header will be extracted. It will be determined from the frame's header whether the payload is destined for the server or for the WAN and routed accordingly. The embodiment comprises one or more graphics processing units (GPUs) to provide rendering services for the clients. Clients connected to the embodiment are stored in a database along with data link layer addresses with information about the functionality of each piece of hardware the client is using and will dynamically create relationships between the clients and hardware. The embodiment will route communications between the server portion of the embodiment and the clients based upon these relationships.

### BRIEF DESCRIPTION OF THE DRAWINGS

FIG. 1 is an exemplary network architecture based upon prior art;

FIG. 2 is an exemplary block diagram of an apparatus for providing services to clients on a network according to an embodiment of the present invention;

FIG. 3 is an exemplary block diagram of a network interface of an apparatus suitable for providing services to clients of static or dynamic hardware on a network;

FIG. 4 is an exemplary block diagram showing the interconnections of the data link layers;

FIG. 5 is an exemplary control flowchart showing an operation of providing services to clients of static or dynamic hardware;

FIG. 6 is an exemplary diagram showing usage information tables and relations stored on an apparatus suitable for providing services to clients of static or dynamic hardware on a network;

FIG. 7 is an exemplary diagram of a user interface suitable for providing information about devices connected to an apparatus of the present invention and providing a means of sending a hardware change request to said apparatus;

FIG. 8 is an exemplary diagram showing device usage before and after a hardware change request;

FIG. 9 is an exemplary diagram showing an interconnect before and after a hardware change request.

### DETAILED DESCRIPTION

An embodiment of the invention will be described hereinafter with reference to the accompanying drawings.

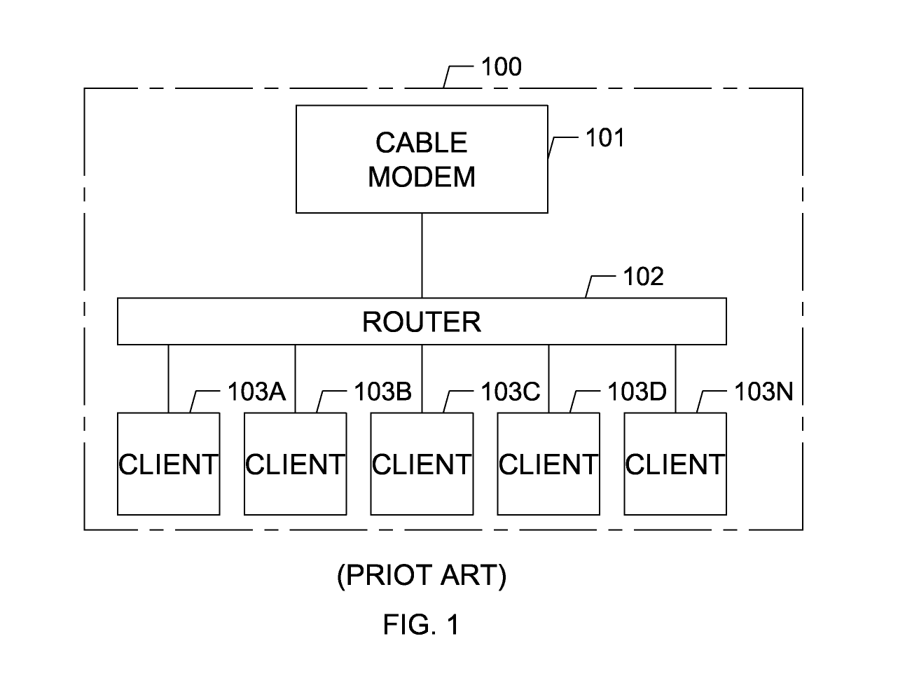

FIG. 1 is an exemplary network architecture based upon prior art.

Referring to FIG. 1, a typical home network 100 is illustrated. The network consists of a cable modem 101, a router 102, and a number of clients 103A-N. If say, for example, client 103A is a home server with the capacity to provide services to other clients on the network; all communications from or to other clients must pass through the router 102 The home server 103A would learn and keep a database of all the other client's 103B-N network layer addresses and upon sending data to one of the client's would have to look up the address and wrap the data in a network layer header, then would have to wrap the packet with data link layer header and send this datagram to the router 102 The router 102 would then unwrap the data link layer header from the packet and check for errors. If no errors are found the router 102 would then look up the data link layer controller associated with the destination network layer address found in the network layer header, wrap the packet in a new data link layer header and finally forward the packet to the intended client.

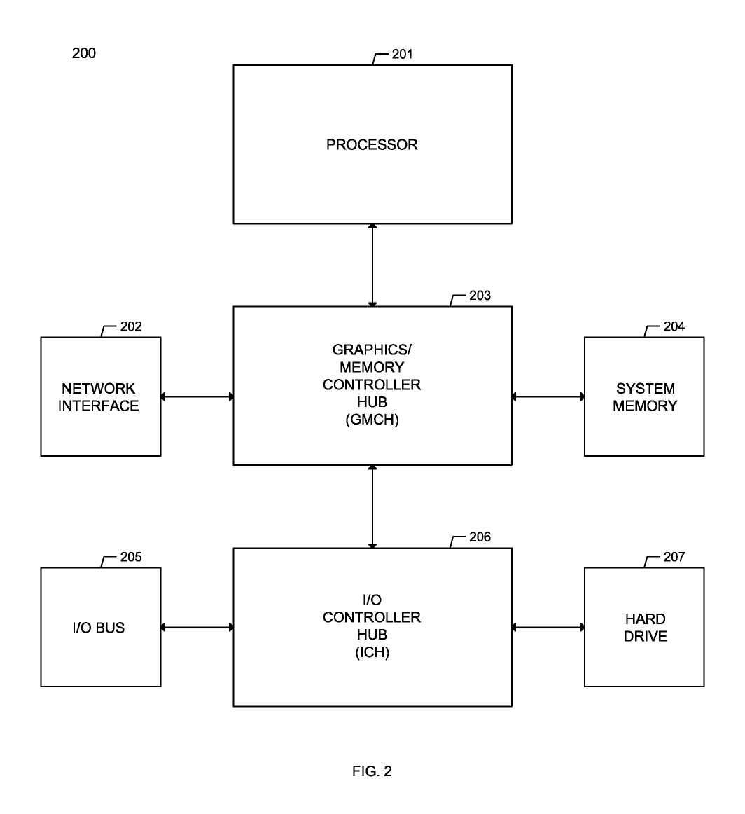

FIG. 2 is an exemplary block diagram of an apparatus for providing services to clients on a network according to an embodiment of the present invention.

Referring to FIG. 2, the apparatus 200 includes a processor 201, a graphics/memory controller hub (GMCH) 203, and an I/O controller hub (ICH) 206. The GMCH is connected to a network interface and to system memory 204. System memory may comprise one or more synchronous dynamic random access memory (SDRAM), Double Data Rate SDRAM (DDSDRAM), or one of many other formats of main system memory.

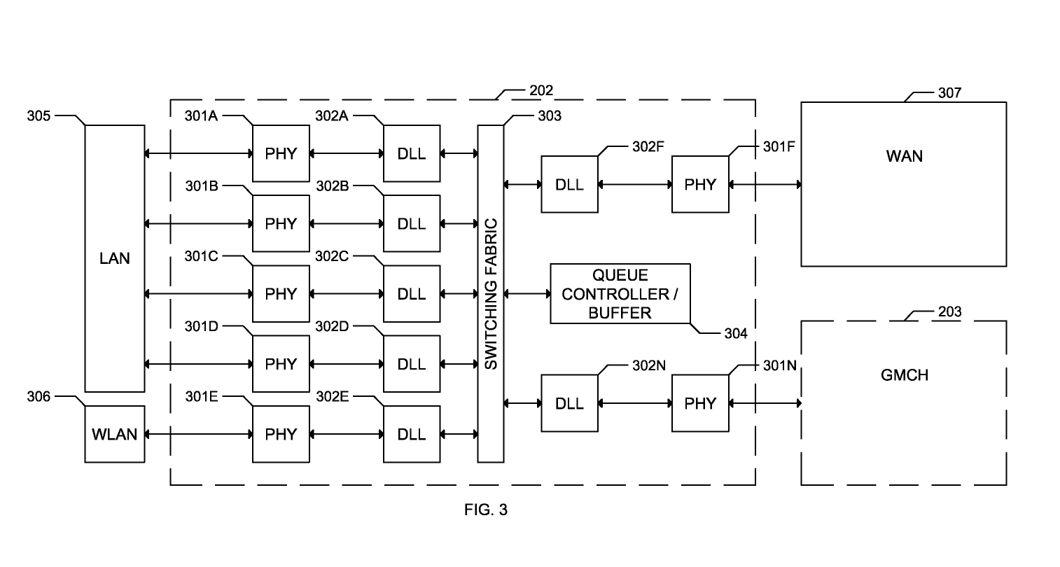

FIG. 3 is an exemplary block diagram of a network interface of an apparatus suitable for providing services to clients of static or dynamic hardware on a network.

Referring to FIG. 3, the network interface 202 interfaces an apparatus of the present invention 200 with a wide area network (WAN) 307, a local area network (LAN) 305, and a wireless local area network (WLAN) 306. The network interface 201 includes a plurality of PHYceivers (PHY) 301A-N for connecting a plurality of data link layer controllers 302A-N to a physical medium such as an optic fiber, a copper cable or an antenna. The data link layer controllers 302A-N are connected to a queue controller/buffer memory 304 through a switching fabric 303. The network interface 202 is configured to dynamically manage the connections between the data link layer controllers 302A-N according to any hardware change requests 407 received by the apparatus of the present invention from clients on a network. The network interface 202 is also configured to act as the gateway between the LAN 305/WLAN 306 and the WAN 307.

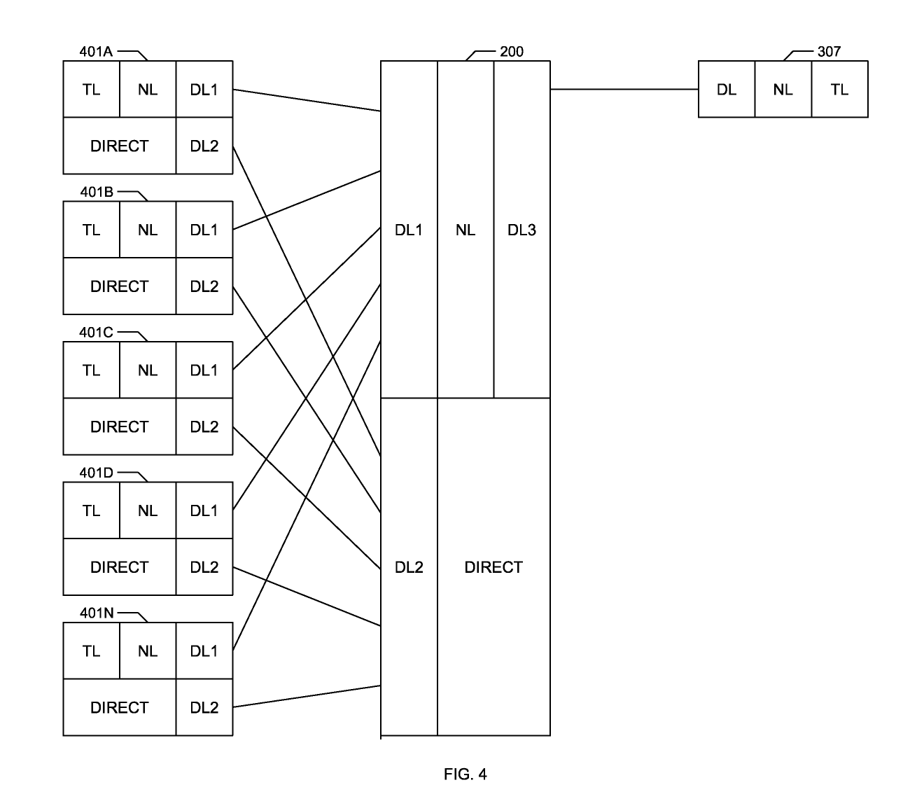

FIG. 4 is an exemplary block diagram showing the interconnections of the data link layers;

Referring to FIG. 4, a server 200 is interconnected to a plurality of clients 401A-N and a WAN 307. Client devices 401A-N are connected to the server 200 and are configured to maintain two unique data link layer addresses. The server 200 is configured to maintain three unique data link layer addresses. If a client 401A-N wishes to transmit data directly to the server without the use of a network layer it transmits the data using its DL2 address and the DL2 address of the server 200. If a client 401A-N wishes to transmit data to a device on the WAN 307 it will use the transport layer protocol and network protocol of the WAN 307 and use the data link layer address DL1 to transmit data to the server 200. The server 200 will then forward the data on to the WAN 307 using its data link layer address DL3. When receiving packets from the WAN 307 the server 200 uses the network layer in order to determine which client the packet is intended for and forwards the packet to that client. The server 200 can transfer data directly to the clients 401A-N with the use of the DL2 addresses of the server 200 and receiving client 401A-N. The server 200 transfers data to the WAN 307 using a transport layer and network layer and its DL3 address.

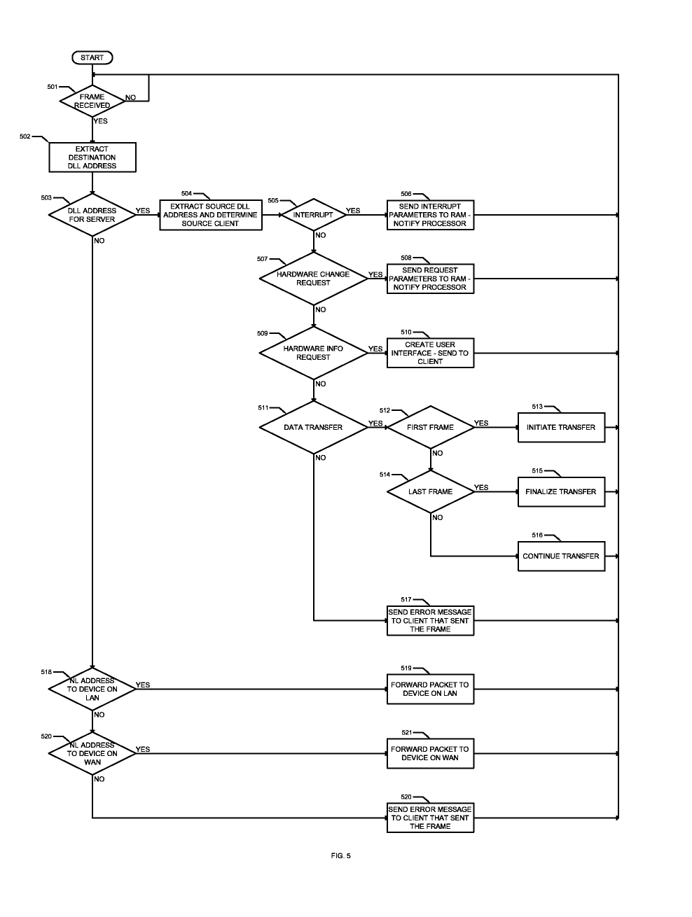

FIG. 5 is an exemplary control flowchart showing an operation of providing services to clients of static or dynamic hardware.

Referring to FIG. 5, the apparatus begins listening on the network. Upon receiving a frame 501 the apparatus extracts the destination data link layer address 502 and determines if the frame is intended for the server 503. If the frame is intended for the server 503 the apparatus extracts the source data link layer controller from the frame and looks up the client associated with this data link layer address 504. If the frame consists of an interrupt 505 the parameters are sent to RAM and the processor is notified of the interrupt 506. If the frame is not an interrupt 505 the apparatus will determine if the frame consists of a hardware change request 507. If the frame does consist of a hardware change request 507 the request parameters are sent to RAM and the processor is notified. If the frame does not consist of a hardware change request 507 it is determined if the frame consists of a hardware info request 509. If the frame does consist of a hardware info request 509 a user interface providing the information of other devices connected to the apparatus of the present invention and usage status of said devices and providing a means for sending a hardware change request is created and sent to the client 510. If the frame does not consist of a hardware info request 509 it is determined if the frame consists of data transfer 511. If the frame does consist of data transfer 511 it is determined if it is the first frame of the transfer 512, the last frame of the transfer 514 or neither. If it is a first frame, the transfer is initialized 513. If it is the last frame, the transfer is finalized. If it is neither the transfer is continued 516. It is to be noted that in this context, data transfer is any communications between clients on a network and the apparatus of the present invention. If the frame does not consist of an interrupt, a hardware change request, a hardware info request or a data transfer an error message is sent to the client that sent the frame.

If the frame is not intended for the server it is determined if the IP address of the packet is intended to be forwarded to another device on the LAN 518 or to a device on the WAN 520. If the packet is intended for the LAN 518 the packet is forwarded to the device on the LAN associated with the received destination IP address 519. If the packet is intended for the WAN 520 the packet is forwarded to the device on the WAN associated with the received destination IP address 521. If the frame is not intended for the apparatus and the packet contained in the frame is not intended for the LAN or WAN an error message is sent to the client that sent the frame.

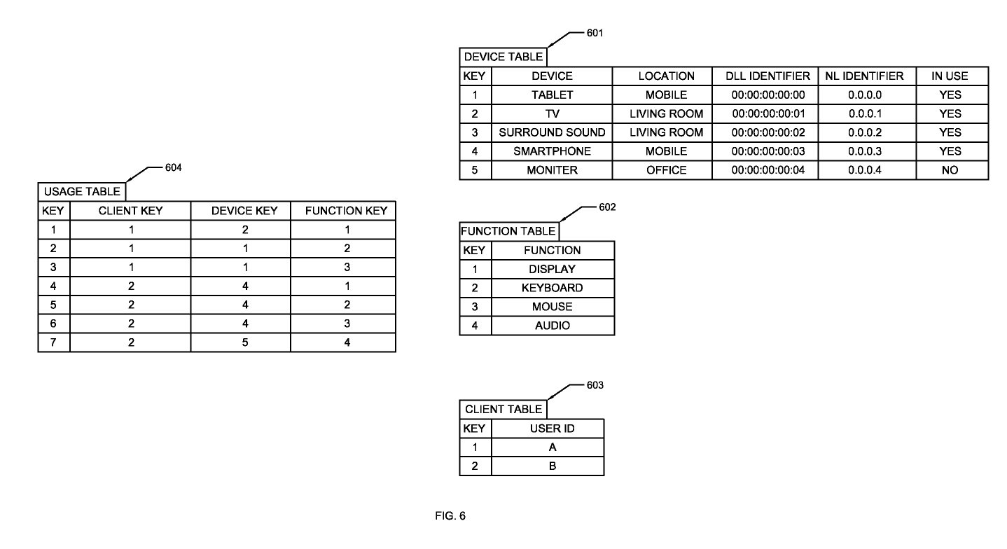

FIG. 6 is an exemplary diagram showing usage information tables and relations stored on an apparatus suitable for providing services to clients of static or dynamic hardware on a network.

Referring to FIG. 6, Usage Table 604 relates information about a client key, a device key and a function key. The client key corresponds to a client in the clients table 603. The clients table 603 contains information about a key and a user id. The device key of the usage table 604 corresponds to a device in the device table 601. The device table 601 contains information about a key, a device, a location, a DLL identifier, a NL identifier, and a usage status. The function key of the usage table 604 corresponds to a function in the function table 602. The function table 602 contains information about a key and a function. In the example of FIG. 5 according to the usage table 604, client A is using a tablet as a keyboard and mouse while using the living room TV as a display. Client B is using a Smartphone as a display, mouse and keyboard while using the living room surround sound as an audio device.

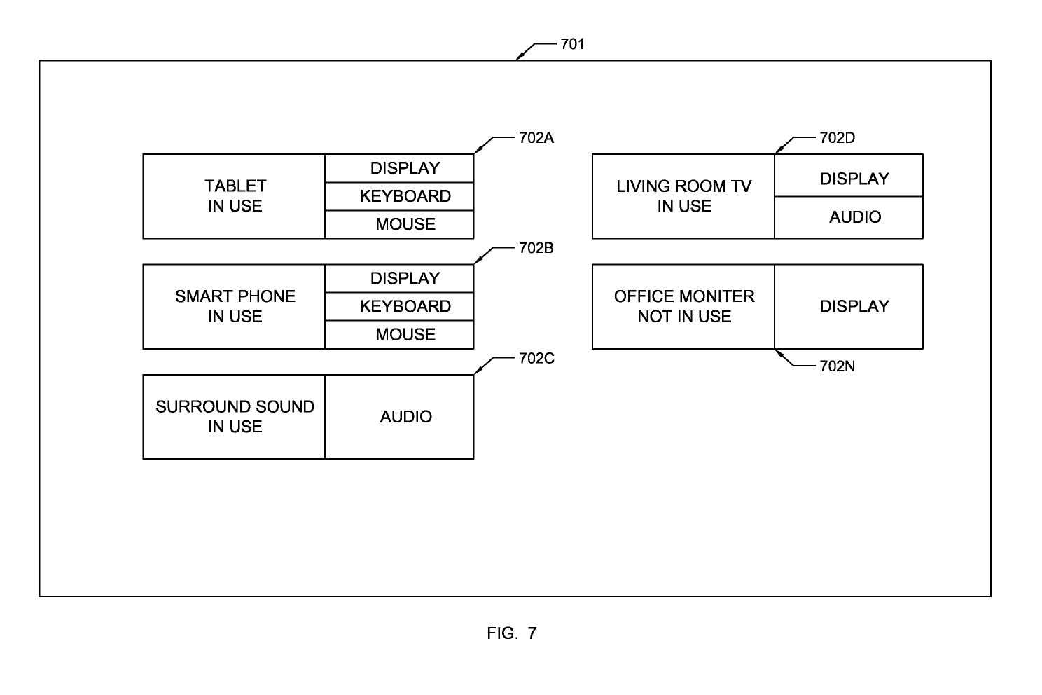

FIG. 7 is an exemplary diagram of a user interface suitable for providing information about devices connected to an apparatus of the present invention and providing a means of sending a hardware change request to said apparatus.

Referring to FIG. 7, upon receiving a hardware info request the server 200 generates a user interface (UI) 701 and sends it to the client's display. The UI 701 consists of a plurality of graphical representations 702A-N of all devices connected to the server 200 indicating the functionality(s) and usage status of each device. If a user wishes to use a device that is currently in use by another client, the user can click on the graphical representation of that device 702A-N sending the client a message. If the client receiving the request agrees to the change the server 200 will generate a UI 701 for that client. The client can then choose to use an additional device for a function or quit the usage of the device that the original request was referencing. Then the server 200 will begin using the device of the user's hardware change request for the specified function. If the user wishes to use a device that is not being used at the time the request for info is made, a hardware change request is sent to the server via the UI 701 by clicking on the desired function of the desired device.

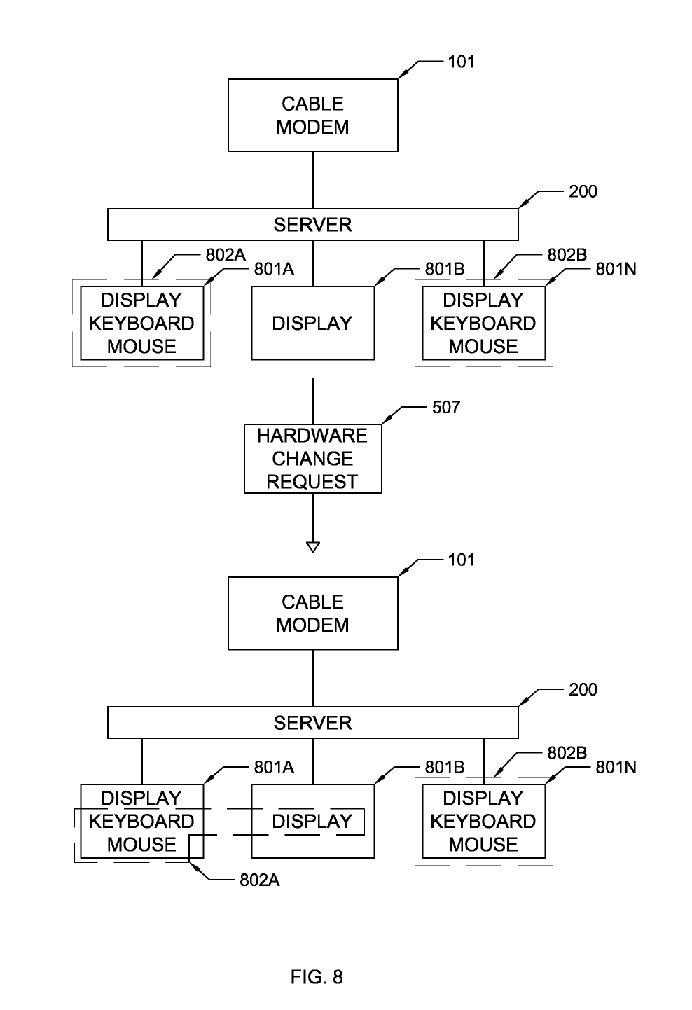

FIG. 8 is an exemplary diagram showing device usage before and after a hardware change request;

Referring to FIG. 8, three devices 801A-N are connected to the server 200 two of which are in use. One device 801A is in use by a client A 802A and another device 801N is in use by client B 802B. Client A 801A sends a hardware change request 507 to the server 200 specifying the third device 801B to be used as the client's 801A display. After the hardware change request is granted by the server 200 the third display 801B is then used as the client's display. It is to be noted here that applications that the client A 802A is running on the server 200 are not notified of this change and do not need to be. The operating system and network interface 202 work in conjunction with one another to completely abstract the device usage away from the applications.

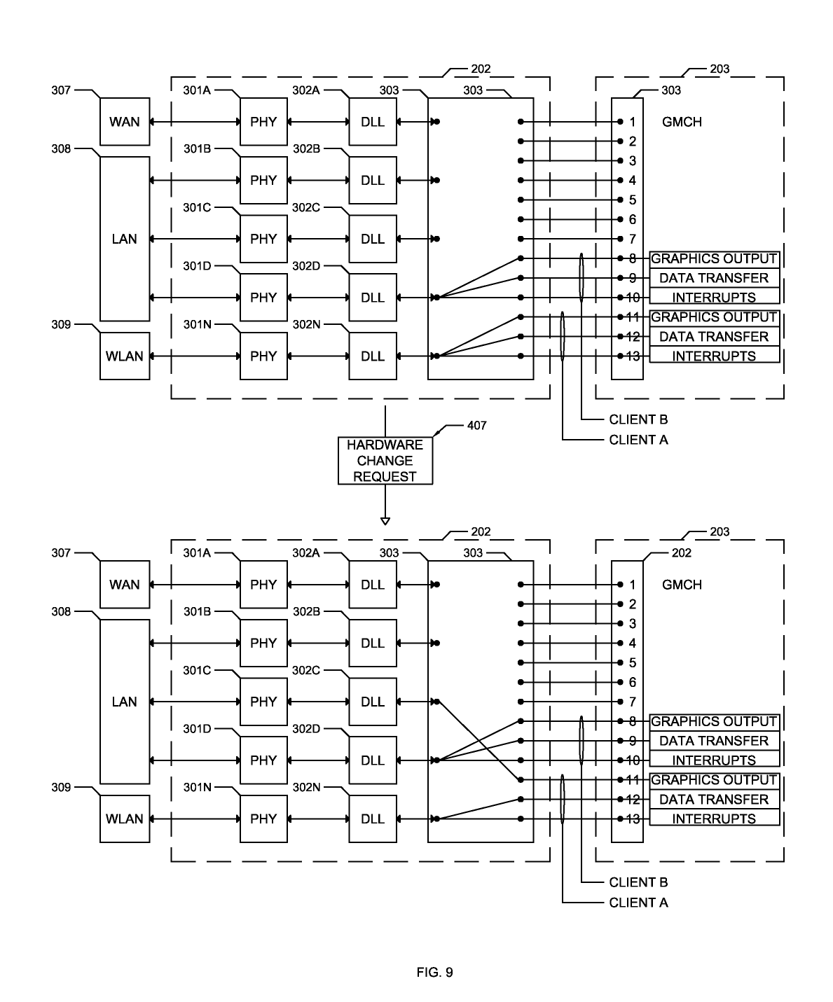

FIG. 9 is an exemplary diagram showing an interconnect before and after a hardware change request.

Referring to FIG. 9, the network interface 202 is connected to the GMCH 203 through a number of lanes 1-13. The server 200 is providing services to two clients. The services interact through a graphics output, data transfer, and interrupts. The GMCH 203 dedicates lane 8 of the interconnect to client B's graphics output, lane 9 to client B's data transfer and lane 10 to client B's interrupts. The GMCH 203 dedicates lane 11 of the interconnect to client A's graphics output, lane 12 to client A's data transfer and lane 13 to client A's interrupts. All of the interactions between client A and the server 200 are routed through the switching fabric to lanes 11, 12 and 13. All of the interactions between client B and the server 200 are routed through the switching fabric to lanes 8, 9 and 10. Upon receipt of a hardware change request from client A specifying a display on the LAN to be used, further graphical output from the server 200 to client A will be routed through the switching fabric to the display's PHY 301C.

While the present invention has been shown and described with reference to a certain preferred embodiment thereof, it will be understood by those skilled in the art that various changes in form and details may be made therein without departing from the spirit and scope of the present invention.

What is claimed is:

1. A method for providing services to clients of static or dynamic hardware on a network comprising: receiving information about a specific piece of hardware connected to a server; receiving and analyzing a request from the client; if the received request is a request for usage information about devices connected to the server, which includes the usage information and the functionality information of the hardware, providing the usage and functionality information to the client that transmitted the request; upon receiving from the client a hardware change request, using the requested device for the specified function for the client that transmitted the hardware change request.

2. The method of claim 1, further comprising, upon receipt of a request to stream the requesting client's session to a plurality of other clients connected to the server, streaming the requesting client's session to the specified clients.

3. The method of claim 1, wherein the usage information comprises the usage status of a device, functionality information of a device, a name, and a description.

4. The method of claim 3, wherein the functionality information comprises information indicating any possible combination of the following functions: keyboard, mouse, display, audio, or phone.

5. The method of claim 1, wherein providing the usage and functionality information to the client that transmitted the request comprises creating a user interface displaying the usage and functionality information of devices connected to the server, and providing the created user interface to a client that transmitted the request.

6. The method of claim 5, wherein the user interface comprises a means for selecting a request for streaming the requesting client's session to a plurality of other clients connected to the server.

7. The method of claim 5, further comprising, upon receiving through the user interface a hardware change request, using the requested device for the specified function.

8. An apparatus for providing services to clients of static or dynamic hardware on a network, comprising: one or more processors; a graphics/memory controller hub (GMCH); a storage device for providing storage services to clients on a network; an I/O controller hub (ICH); and a network interface comprising a plurality of PHYceivers and data link layer controllers, a switching fabric, buffer memory, and queue controller.

9. The apparatus of claim 8, wherein the network interface is configured to route data between clients and said apparatus, between clients and a WAN, and between the said apparatus and a WAN.

10. The apparatus of claim 8, wherein upon receiving a request to stream the requesting client's session to a plurality of other clients connected to the server, streaming the requesting client's session to the specified clients.

11. The apparatus of claim 8, further comprising a database manager for dynamically associating hardware data link layer addresses with client devices and the functionality of said devices.

12. The apparatus of claim 8, further comprising upon receiving a request from a client; if the received request is a request for usage information about devices currently connected to the server, which includes the usage information and the functionality information of the hardware, providing the usage and functionality information to the client that transmitted the request; upon receiving from the client a hardware change request, using the requested device for the specified function for the client that transmitted the hardware change request.

13. The apparatus of claim 12, wherein the usage information comprises the usage status of a device, functionality information of a device, a name, and a description.

14. The apparatus of claim 13, wherein the functionality information comprises information indicating a possible combination containing any of the following functions: keyboard, mouse, display, audio, or phone.

15. The apparatus of claim 12, wherein providing the usage and functionality information to the client that transmitted the request comprises creating a user interface displaying the usage and functionality information of all devices connected to the server, and providing the created user interface to a client that transmitted the request.

16. The apparatus of claim 15, wherein the user interface comprises a means for selecting a request for streaming the requesting client's session to a plurality of other clients connected to the server.

17. The apparatus of claim 15, further comprising, upon receiving through the user interface a hardware change request, using the requested device for the requested function.

19. A system comprising: one or more servers configured to route data between clients and said apparatus, between clients and a WAN, and between the said apparatus and a WAN, and is configured to provide services to clients of static or dynamic hardware without interrupting said client's user session; clients connected to said servers who may dynamically change hardware.
